(19) United States
(12) Patent Application Publication
(10) Pub. No.: US 2007/0220019 A1
(43) Pub. Date: Sep. 20, 2007

(54) Dynamic site definition

(75) Inventors: Dmitry Zhiyanov, Woodinville, WA (US); Hitesh Jawa, Bellevue, WA (US); Meyyappan Meenakshisundaram, Sammamish, WA (US); Ramana Parimi, Sammamish, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/384,140

(22) Filed: Mar. 17, 2006

(51) Int. Cl. G06F 7/00

(52) U.S. Cl. 707/100

(57) ABSTRACT

Creating a web site using a site definition application and an additional application is disclosed. Metadata in the additional application may store page definitions and the site definition application may be configured such that the page definitions are supplied by the additional application.

### BACKGROUND

Web site development software is designed as a platform to support different types of web sites. This software extends the template architecture so that multiple site definitions and templates can be created by application developers and used in a deployment. Site Definition consist of multiple XML files located in the file system of a front-end Web server. These XML files defines the various aspects of the site such as document libraries, lists and web part pages that are created when a new site is provisioned using this site definition.

Once the site is created, any further changes done to the site definition in the file system will not be reflected on any existing sites. The only way to refresh these existing sites with the modified site definition is to create a new site, migrate the content and delete the old site. This is an onerous task, involving significant down time and is error prone.

### SUMMARY

Creating a web site using a site definition application and an additional application is disclosed. The site definition application may not be modified but the resulting web page may be easily updated. Metadata in the additional application may store page definitions and the site definition application may be configured such that the page definitions are supplied by the additional application. At the time of site creation, the page definitions may be pushed to the site definition application and the web site may be created using the page definitions pushed to the site definition application. The additional application may be able to access a variety of data sources including databases, even when the databases are of different types.

### DRAWINGS

FIG. 1 is a block diagram of a computing system that may operate in accordance with the claims;

FIG. 2 is a flowchart of a method in accordance with the claims;

FIG. 3 is an addition flowchart of an example system in accordance with the claims;

FIG. 4 is an illustration of a sample site definition application to help create a web site;

FIG. 5 is an illustration of a template selection wizard;

FIG. 6 is a sample display which allows the selection of various options for a web site; and

FIG. 7 is an illustration of a display where page definitions are imported.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

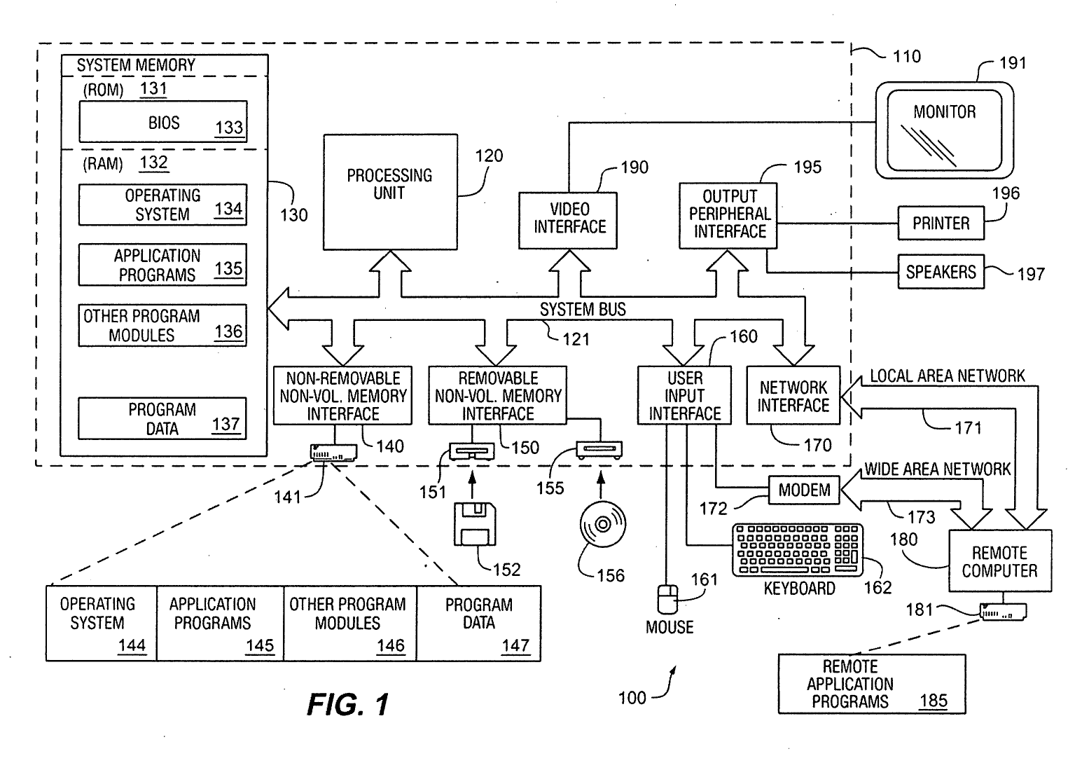

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus also known as Mezzanine bus, and the Peripheral Component Interconnect-Express (PCI-E).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

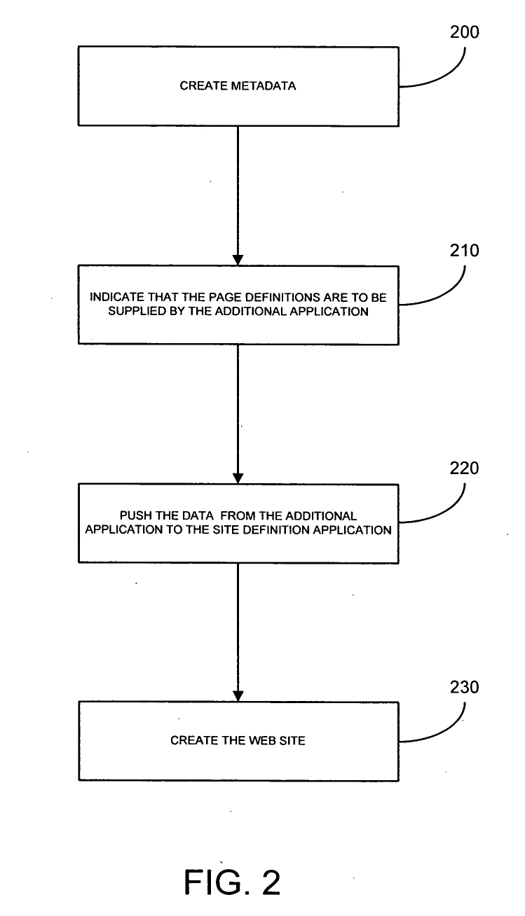

FIG. 2 may illustrate a method of creating a web site using a site definition application and an additional application where the site definition application is not modified in accordance with the claims. Site definition applications are well known. One such example is Sharepoint from Microsoft® Corporation. Other applications may be quite varied but most commonly will be applications that supply data to web sites or web based applications. An example would be an enterprise resource program (“ERP”) such as DynamicsAX from Microsoft® Corporation.

At block 200, the method may create metadata in the additional application to store page definitions. For example, an ERP system may provide page definition data to a site definition application as the ERP system may be a web based system. As an initial point, it may be necessary to separate web resources into changeable web resource and static web resources with the changeable web resources being stored locally in the additional application and the static data being stored on servers. For example, if DynamicsAX from Microsoft is used as the additional software, it is unlikely that the standard grey bar at the top of the eventual web page will change. Accordingly, it may not be a changeable item and it may be stored on a server. However, if shipping rates are used, these will change often. Accordingly, these rates may be changeable, may be stored in the metadata of DynamicsAX and may be pushed to users at the time of site creation.

At block 210, the method may indicate in the site definition application that the page definitions are to be supplied by the additional application. For example, Sharepoint may be used to construct templates for a web based ERP system such as DynamicsAX. The Sharepoint template may use references to data stored by DynamicsAX to create the web site. The data may be document libraries, lists and web part pages.

The data may be stored as XML files. In addition, the data may be stored as metadata in the addition application, such as metadata in the DynamicsAX application. In one example, the data may be stored in an object tree in DynamicsAX and the Sharepoint system may know to look at the metadata to obtain document libraries, lists and web part pages, etc.

Changes to multiple pages may be stored as a single metadata file. Logically, the changes may be created by multiple users and combined into a single file that is pushed to the final web site users. The metadata may be created using authoring tools, making proper metadata creation simple.

As previously mentioned, the data may be stored in a database. This database may pull data from a plurality of databases and these databases may be in a variety of formats. For example, the databases may use Access format or Oracle format. In another embodiment, the site creation application may call for data from the additional application and the additional application may pull data from a variety of databases of different types. For example, a Sharepoint service may call to DynamicsAX for site definition data. DynamicsAX may have the capability to call for data from an Oracle database, an Access database, a MYSQL database, etc. Accordingly, the Sharepoint service in effect may be able to access a variety of different database types without having to have specific knowledge of the different databases being used.

At block 220, the method may at the time of site creation, push the data such as page definitions from the additional application to the site definition application. In the previous example, the page definitions in DynamicsAX would be pushed to the Sharepoint system. The data may be pushed to all sites, some sites or just one specific site. For example, users of DynamicsAX may speak a variety of languages and some updates may only relate to users that speak French. Accordingly, an update to French DynamicsAX users may only be pushed to users of DynamicsAX in French.

At block 230, the method may create the web site using the page definitions pushed to the site definition application. In the previous example, the web based Sharepoint system would use the data from DynamicsAX to create the web pages to operate the web-based DynamicsAX.

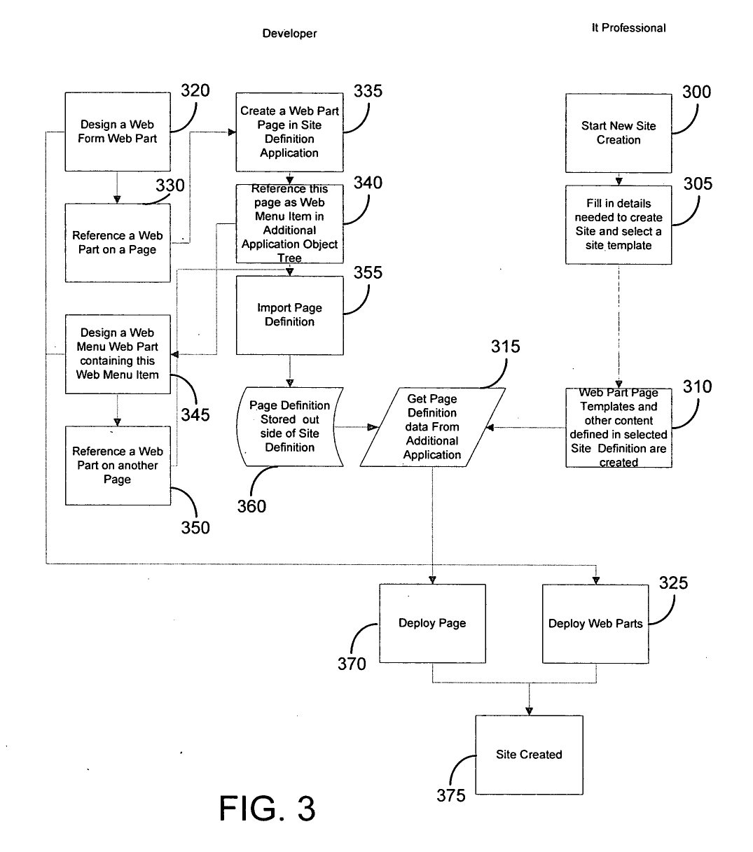

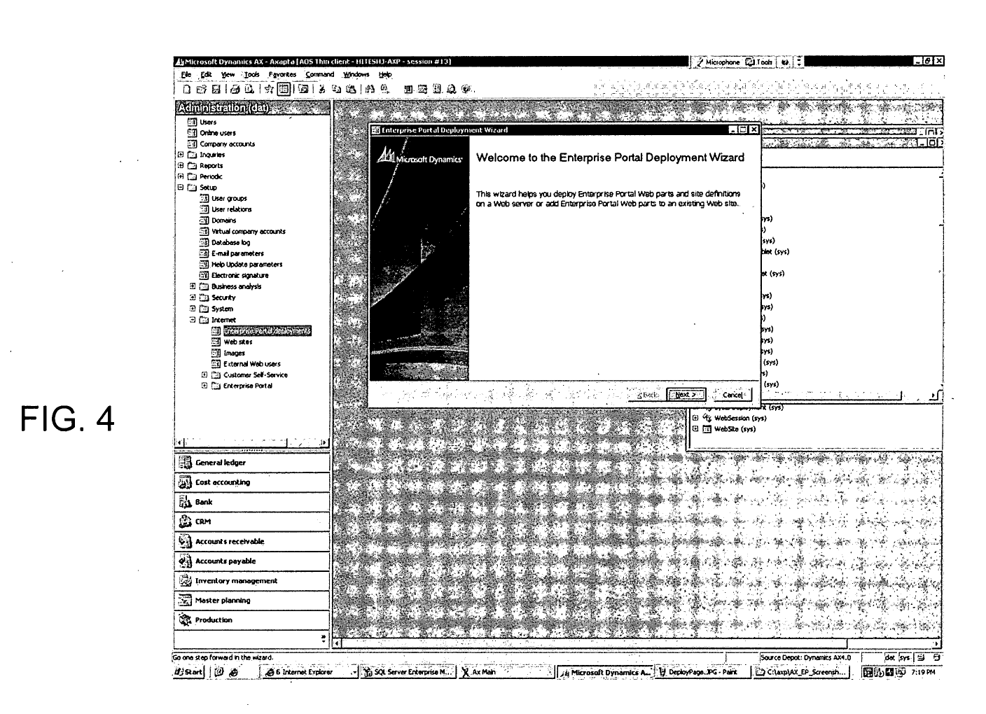

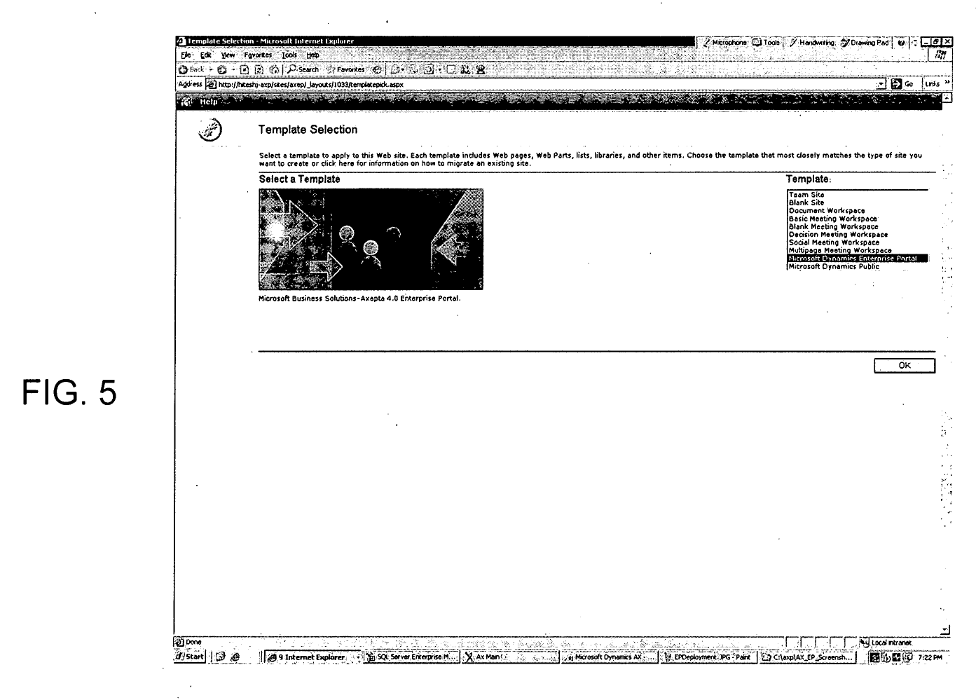

FIG. 3 may be another embodiment of the method. At block 300, creation of a new site may begin. The site creation may be accomplished using the site definition application, such as Microsoft Sharepoint. The site definition application may also be included inside another application. For example, DynamicsAX may have a version of Microsoft Sharepoint included. FIG. 4 may be an illustration of a sample site definition application to help create a web site. At block 305, the method may fill in details needed to create the eventual web site, including selecting the template to be used for the site. The templates may be stored as ASPX files on a file system. Templates are well know and are often included in site definition applications. FIG. 5 may be an illustration of a template selection wizard.

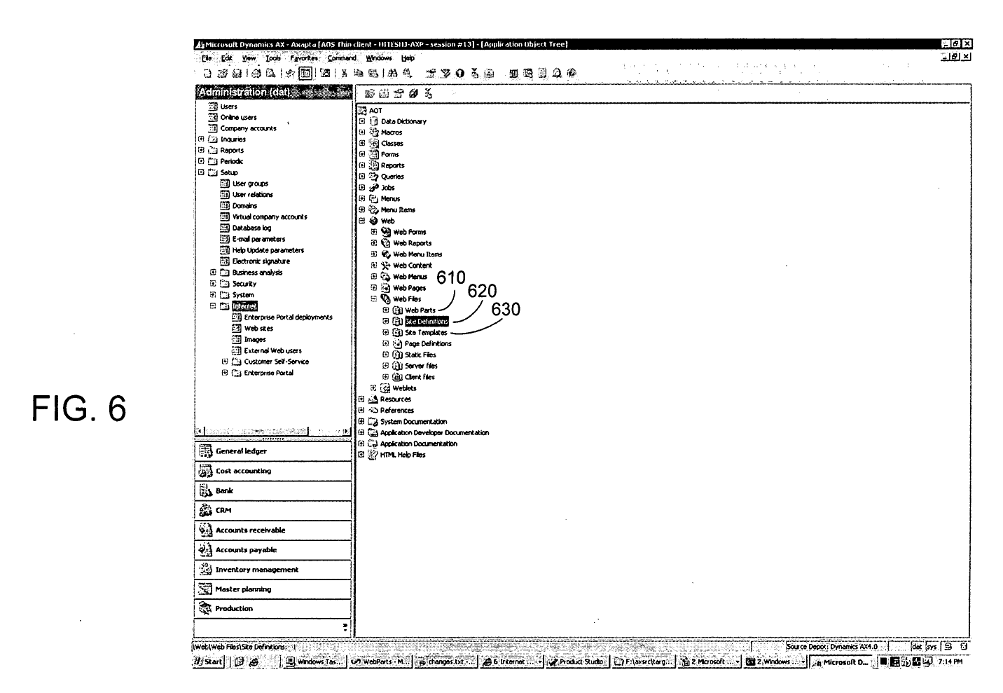

At block 320, the method may allow the design of a web form web part. Referring briefly to FIG. 6, the web page parts may be designed by using a menu option 610 that may be expanded to present various options related to web parts. The completed web form web parts may be communicated to block 325 (FIG. 3) where web parts are used as described in steps 370-375. In addition, the web form web parts may be communicated to block 330, where the method may reference a web part on a page. Control may pass to block 335 where the method may create a web part page in the site definition application. In other words, the web part may be added to the eventual web page using the site definition application. Control may pass to block 340 where the method may reference the page from block 335 as a web menu item in the additional application object tree. For example, if DynamicsAX is the additional application, the page as a Web menu item in the DynamicsAX object tree. FIG. 6 may be a sample display which allows the selection of various options for a web site. For example, by selecting site definitions 620, site definitions may be modified and by selecting site templates 630, site templates may be selected and modified. At block 310 (FIG. 3), the method may create the web page parts templates and other content defined in the selected site definitions. At block 315, the site definition application may obtain page definition data from the additional application.

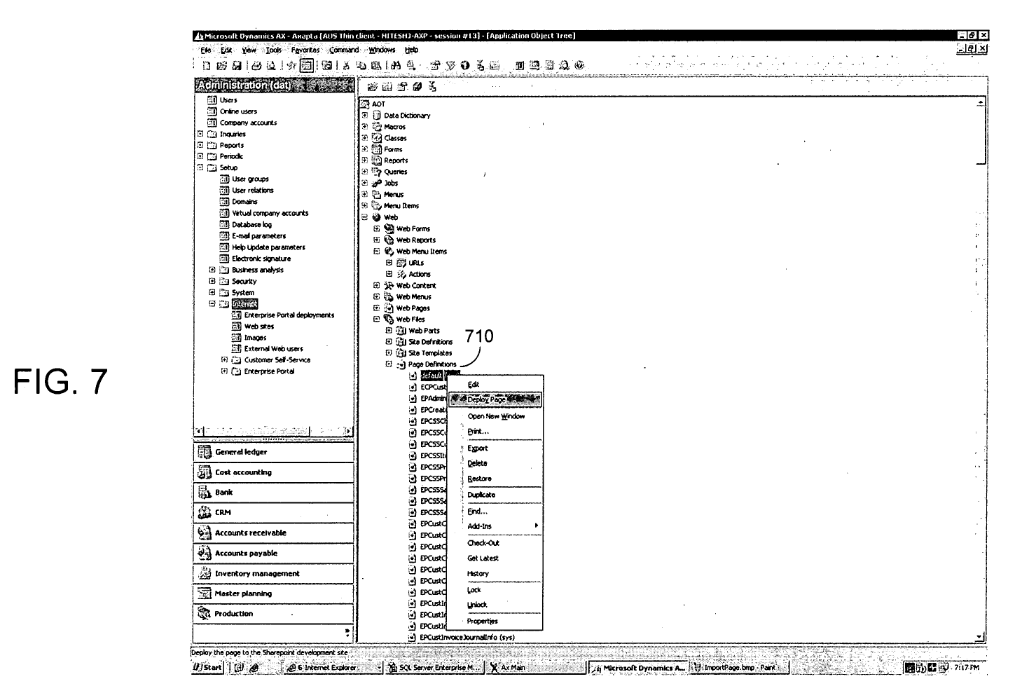

At block 345, the method may allow the design of a web menu web part in the additional application containing the web menu item from block 340. This web part may then be communicated to block 325. In addition, at block 350, the method may allow the reference of the web part on another page. Control may to block 355 where the method may import page definitions. FIG. 7 may be an illustration of a display where page definitions 710 are imported. The page definitions 710 may be standard page definitions, proprietary page definitions are page definitions from a third party and various options may be available.

At block 360, the page definition may be stored outside of the site definition. In other words, the page definitions are separated and stored remotely from the site definition. The site definition may receive the page definitions at the time the site is created.

Referring again to block 315, the page definitions from block 360 and the web part page templates from block 310 are received. At block 370, the method may attempt to deploy the web page. This may occur by a user selecting to open the page or having a first page select to open the page in question. At block 375, the web site may be created by deploying the web parts from block 325 with the deploy page data from block 370.

As a result of the design, integrated development of web sites and web components results. For example, a web page certainly contains references to its web components (web parts). But the reverse is true as well as a “menu” web part contains references to web pages which can be navigated from the menu. A “form” web part contains a reference to web page which needs to be displayed when the user clicks “submit” button. As site definition applications are oblivious to other application web components displayed on the page, it can not provide the integrated development of web pages and web components and ensure consistency between the two. By bringing web pages and web components together (as well as other parts of the site) into one integrated development environment, integrated development of web sites and web components results. By deploying web pages and web components together, consistent behavior on the production system may be achieved.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. An method of creating a web site using a site definition application and an additional application where the site definition application is not modified comprising:
creating metadata in the additional application to store page definitions;
indicating in the site definition application that the page definitions are to be supplied by the additional application;
at the time of site creation, pushing the page definitions to the site definition application; and
creating the web site using the page definitions pushed to the site definition application.

2. The method of claim 1, wherein creating metadata further comprises storing document libraries, lists and web part pages.

3. The method of claim 1, further comprising storing the web page definitions as XML files.

4. The method of claim 3, further comprising creating the web part pages from the page definition XML.

5. The method of claim 1, further comprising allowing changes to the metadata to be propagated to existing sites.

6. The method of claim 1, further comprising allowing change to the metadata to be propagated to specific existing sites.

7. The method of claim 1, further comprising allowing changes to multiple pages to be combined into a single file.

8. The method of claim 1, further comprising separating web resources into changeable web resource and static web resources and storing the changeable web resources locally.

9. The method of claim 1, further comprising storing metadata in an object tree.

10. The method of claim 1, further comprising storing the data in a separate database wherein the separate database pulls data from additional databases stored in a plurality of database formats.

11. The method of claim 1, further comprising having the page definition system call the additional application for data and the additional application calls a plurality of databases where the plurality of databases are stored in a plurality of formats.

12. A computer readable medium configured to store computer executable code, the computer executable code for creating a web site using a site definition application and an additional application where the site definition application is not modified comprising code for:
creating metadata in the additional application to store page definitions wherein the metadata further comprises at least one of document libraries, lists and web part pages and wherein the page definitions are stored as XML files;
indicating in the site definition application that the page definitions are to be supplied by the additional application;
at the time of site creation, pushing the page definitions to the site definition application; and
creating the web site using the page definitions pushed to the site definition application.

11. (canceled)

12. (canceled)

13. The computer readable medium of claim 10, further comprising computer executable code for comprising allowing changes to multiple pages to be combined into a single file.

14. The computer readable medium of claim 10, further comprising computer executable code for separating web resources into changeable web resource and static web resources and storing the changeable web resources locally.

15. The computer readable medium of claim 10, further comprising computer executable code for storing metadata in an object tree.

16. The computer readable medium of claim 10, further comprising computer executable code for storing the data in a separate database wherein the separate database pulls data from additional databases stored in a plurality of database formats.

17. A computer system comprising a processor capable of executing computer executable code, a memory capable of storing computer executable code, and an input/output circuit where the processor is programmed to execute computer executable code for creating a web site using a site definition application and an additional application where the site definition application is not modified, the code comprising code for:
creating metadata in the additional application to store page definitions wherein the metadata further comprises at least one of document libraries, lists and web part pages and wherein the page definitions are stored as XML files;
indicating in the site definition application that the page definitions are to be supplied by the additional application;
at the time of site creation, pushing the page definitions to the site definition application;
creating the web site using the page definitions pushed to the site definition application; and
storing the metadata in a separate database wherein the separate database pulls data from additional databases stored in a plurality of database formats.

18. The computer system of claim 17, further comprising computer executable code for allowing changes to the metadata to be propagated to existing sites or specific sites.

19. The computer system of claim 17, further comprising computer executable code for separating web resources into changeable web resource and static web resources and storing the changeable web resources locally.

20. The computer system of claim 17, further comprising computer executable code for storing metadata in an object tree.
